(19) United States
(12) Patent Application Publication
(10) Pub. No.: US 2026/0134039 A1
(43) Pub. Date: May 14, 2026

(54) METHOD, DEVICE, AND STORAGE MEDIUM FOR DIVERSE DATA SYNTHESIS

(71) Applicant: Tencent America LLC, Palo Alto, CA (US)

(72) Inventors: Tao GE, Palo Alto, CA (US); Dong YU, Palo Alto, CA (US)

(73) Assignee: Tencent America LLC, Palo Alto, CA (US)

(21) Appl. No.: 18/947,779

(22) Filed: Nov. 14, 2024

(51) Int. Cl. G06F 16/906; G06F 16/908; G06F 16/951

(52) U.S. Cl. CPC G06F 16/906; G06F 16/908; G06F 16/951

(57) ABSTRACT

This application provides a method and apparatus, a device, and a storage medium for data processing and LLM training. The method includes: extracting raw data representing world knowledge from an information domain comprising websites, the raw data comprising a set of data elements, and each data element in the set of data elements comprising at least one of: a text portion; an image portion; an audio portion; or a video portion; using the each data element in the set of data elements as input, instructing a first LLM to infer a seed persona corresponding to the each data element; and storing the seed persona into a persona set comprising at least one persona.

### FIELD OF THE TECHNOLOGY

This application relates to the field of information technologies, and in particular, to method and apparatus, a device, and a storage medium for diverse data synthesis.

### BACKGROUND OF THE DISCLOSURE

Large language model (LLM), such as ChatGPT, is a type of Artificial Intelligence (AI) designed to understand and generate human-like text. LLMs leverage deep learning techniques, particularly transformer-based architectures, to learn complex patterns in text data and are capable of performing a wide range of natural language processing (NLP) tasks. LLMs learn from vast datasets which include text from websites, books, journals, newspapers, and more, empowering them to recognize grammar, syntax, and nuances in language(s). High quality training datasets are critical for training and tuning LLMs. As well-curated datasets allow the LLM to learn from a wide scope of domains, topics, and contexts, enabling it to handle various tasks including text generation, translation, summarization, question-answering, and analysis.

However, in the related art, obtaining high-quality training datasets is both expensive and time-consuming.

### SUMMARY

Embodiments of this disclosure provide a method and apparatus, a device, and a storage medium for constructing a persona hub and using persona from the persona hub to generate synthetic data, which can improve the training and tuning of LLM(s). The technical solution is as follows:

In some embodiments, a method for data processing and LLM training is disclosed. The method may be performed by a computer device and may include: extracting raw data representing world knowledge from an information domain comprising websites, the raw data comprising a set of data elements, and each data element in the set of data elements comprising at least one of: a text portion; an image portion; an audio portion; or a video portion; using the each data element in the set of data elements as input, instructing a first LLM to infer a seed persona corresponding to the each data element; and storing the seed persona into a persona set comprising at least one persona.

In some embodiments, there is a computer device comprising a processor and a memory, wherein the processor is configured to read code from the memory and implement any methods recited in any of the embodiments.

In some embodiments, a computer program product comprising a computer-readable program medium code stored thereupon, the code, when executed by a processor, causing the processor to implement any method recited in any of the embodiments.

The technical solution provided in this application may include the following beneficial effects:
1) Constructing a persona hub at large scale (e.g., 1 billion entries). This scale provides substantial diversity for personas.
2) The personal hub includes seed personas, which may be inferred from web data using an LLM; and supplementary personas, which may be inferred from the seed personas, based one, for example, relationship between personas.
3) Customized prompts may be created which is based on specific personas selected from the persona hub. As the prompts are tailored with diversified personas, synthesized data generated from an LLM will also feature high diversity.

It is known in the field that when training data lack diversity, the LLM will experience at least following issues:
1) A lack of diversity in the training data limits the model's ability to generalize well across different domains or user contexts, which leads to poor performance, and inability to support users with different backgrounds.
2) The resulting LLM has limited problem-solving abilities, and inaccurate representation of the real world.
3) Using narrow scope training data may cause LLM collapse.

Embodiments in this disclosure will solve the above issues, by providing rich, diverse synthetic data based on diversified personas.

It is to be understood that, the foregoing general descriptions and the following detailed descriptions are merely for illustration and explanation purposes and are not intended to limit this application.

### BRIEF DESCRIPTION OF THE DRAWINGS

Accompanying drawings herein are incorporated into a specification and constitute a part of this specification, show embodiments that conform to this application, and are used for describing a principle of this application together with this specification.

FIG. 1 is a framework diagram of LLM model training, and LLM model interaction with computer device.

FIG. 2 shows various LLM prompts may be constructed using different personas.

FIG. 3 shows a compressed view of world knowledge using persona hub, and decompress view of world knowledge generated from the persona hub.

FIG. 4 shows an exemplary text-to-person solution.

FIG. 5 shows that persona descriptions will be fine-grained if input texts involve many detailed elements.

FIG. 6 shows an exemplary persona-to-person solution.

FIGS. 7A, 7B, and 7C show exemplary 0-shot prompting, few-shot prompting, and persona-enhanced few-shot prompting, respectively.

FIG. 8 shows various exemplary prompts created with a focus, or a difficulty level.

FIG. 9 shows various prompts created with a persona in a same field of the question to be created.

FIG. 10 shows an exemplary high level flow chart of an embodiment according to this disclosure.

FIG. 11 shows a flow chart of method according to an example embodiment of the disclosure; and

FIG. 12 shows a schematic illustration of a computer system in accordance with example embodiments of the disclosure.

### DESCRIPTION OF EMBODIMENTS

Exemplary embodiments are described in detail herein, and examples of the exemplary embodiments are shown in the accompanying drawings. When the following description involves the accompanying drawings, unless otherwise indicated, the same numerals in different accompanying drawings represent the same or similar elements. The implementations described in the following exemplary embodiments do not represent all implementations that are consistent with this application. On the contrary, the implementations are merely examples of apparatuses and methods that are described in detail in the appended claims and that are consistent with some aspects of this application.

It is to be understood that, in this specification, “several” refers to one or more, and “plurality of” refers to two or more. “And/or” describes an association relationship between associated objects and represents that three relationships may exist. For example, A and/or B may represent the following three cases: only A exists, both A and B exist, and only B exists. The character “/” generally indicates an “or” relationship between the associated objects.

This application provides a method, which can generate personas based on information scraped from real world, for example, websites, book, journals, etc. These generated personas may be used as seed persons, to generate more personas related with the seed personas. Based on these personas, a persona hub is created, which may be used to generate persona-based LLM prompt and drive the LLM to generate persona oriented synthetic data. For ease of understanding, several terms involved in this application are explained below.

### 1) Persona

A persona refers to a set of characteristics that define a virtual person's simulated characteristics, personality, trait, identity, expertise, behavioral pattern, communication style, or personal profile, which collectively shape how the virtual person responds to user prompt to an LLM. Personas are crucial for customizing the LLM's output to specific contexts, audiences, or use case scenarios, enabling more natural, relevant, and effective conversations. They allow the LLM to maintain consistency in tone and content, making interactions feel more human-like and contextually appropriate. Creating well-defined personas also enhances user experience by making responses feel personal and aligned with the user's expectations, whether the task is for educational, business, tool development, or casual dialogue.

### 2) Artificial Intelligence (AI)

AI involves a theory, a method, a technology, and an application system that use a digital computer or a machine controlled by the digital computer to simulate, extend, and expand human intelligence, perceive an environment, obtain knowledge, and use knowledge to obtain an optimal result. In other words, AI is a comprehensive technology of computer science, which attempts to understand essence of intelligence and produces a new intelligent machine that can react in a manner similar to human intelligence. AI is to study the design principles and implementation methods of various intelligent machines, to enable the machines to have the functions of perception, reasoning, and decision-making.

The AI technology is a comprehensive discipline and relates to a wide range of fields including both hardware-level technologies and software-level technologies. The basic AI technologies generally include technologies such as a sensor, a dedicated AI chip, cloud computing, distributed storage, a big data processing technology, an operating/interaction system, and electromechanical integration. AI software technologies mainly include several major directions such as a computer vision (CV) technology, a speech processing technology, a natural language processing technology, and machine learning (ML)/deep learning.

### 3) Machine Learning (ML)

ML is a multi-disciplinary subject involving a plurality of disciplines such as probability theory, statistics, approximation theory, convex analysis, and algorithm complexity theory. ML specializes in studying how a computer simulates or implements a human learning behavior to obtain new knowledge or skills, and reorganize an existing knowledge structure, so as to keep improving its performance. ML is the core of AI, is a basic way to make the computer intelligent, and is applied to various fields of AI. ML and deep learning generally include technologies such as an artificial neural network, a belief network, reinforcement learning, transfer learning, inductive learning, and learning from demonstrations.

### 4) Large Language Model (LLM)

An LLM is an advanced type of AI aiming to understand, generate, and manipulate human language. Built on deep learning architectures, particularly transformer models, LLMs are trained on vast amounts of text data, allowing them to learn patterns, grammar, and contextual relationships in language. They can perform a wide range of natural language processing tasks, such as answering questions, generating text, translating languages, and summarizing content. By leveraging their ability to generalize from extensive training data, LLMs can adapt to diverse domains and provide contextually relevant, human-like responses.

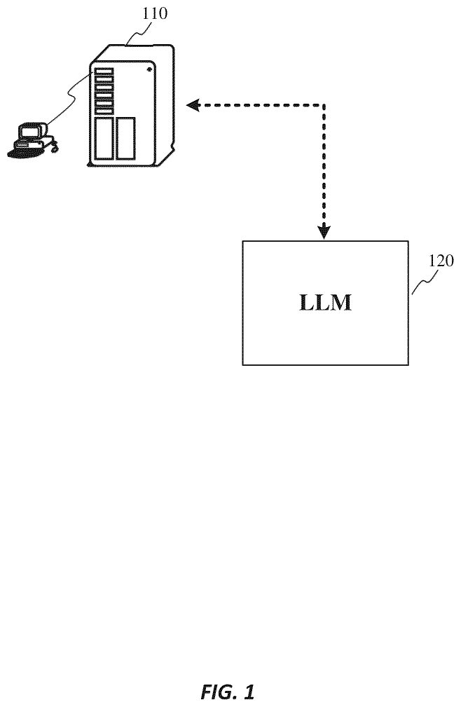

FIG. 1 shows an example framework diagram for implementing the embodiments according to this disclosure. As shown in FIG. 1, in the model training stage, a computer device 110 is used for extracting data from public domain, such as web sites. The computer device 110 may further construct a persona hub according to embodiments of this disclosure. Once the persona hub is created, the computer device 110 may be used to issue instructions (prompts) to the LLM 120, which will generate desired synthetic data according to the instructions. The instructions herein may specifically be based on one or more personas stored in the persona hub.

The computer device 110 may be computer devices with a machine learning capability. For example, the computer device may be a fixed computer device such as a personal computer, a server, or a fixed research device; alternatively, the computer device may be a mobile computer device such as a tablet computer, or an e-book reader. The computer device 110 may be used to implement embodiments according to this disclosure.

In this disclosure, more than one computer device 110 may be used. Also, more than one LLM 120 may be used. For example, LLMs of different sizes, different types may be used based on, for example, a particular use case scenario.

Synthetic data, typically referring to data generated by models or algorithms rather than directly by humans, becomes increasingly valuable for training LLMs. This is because synthetic data may offer several advantages and benefits.

Synthetic data helps to address data availability and scalability issues. Synthetic data can be generated in large scale, overcoming the limitations of relying on human-labeled or real-world data, which may be expensive, or time-consuming to collect. Synthetic data enables the creation of vast, diverse datasets for training and tuning LLMs more effectively.

Synthetic data is cost effective. Generating synthetic data using algorithms or models can significantly reduce the costs associated with manual data collection, annotation, and curation. Therefore, compared with human-generated datasets, synthetic data is more cost-effective.

Synthetic data provides augmentation to real world data, by filling gaps, especially in cases where collecting additional real data is impractical. This augmentation can enhance the representativeness of the training data, leading to more robust and generalized LLM models.

Synthetic data preserves data security in areas where real-world data includes sensitive information (e.g., private data such as medical records, financial data), synthetic data allows for the creation of training datasets that retain statistical properties without exposing private or personally identifiable information.

Additionally, synthetic data may help to accelerate LLM model development and iteration, as it may be obtained quicker than real-world datasets.

There is a growing interest in data synthesis using LLMs: by specifying a data synthesis prompt, an LLM is expected to produce a corresponding synthetic data.

As described earlier, the datasets used for training LLMs must be of high quality. In practice, however, it is non-trivial to create high quality synthetic data at scale. One bottleneck has to do with diversity of synthetic data. While we can scale up the quantity of synthetic data, it is difficult to ensure its diversity scales up as well. Without considering sampling, an LLM can only produce 1 instance given a data synthesis prompt. Therefore, to create diverse synthetic data at scale (e.g., 1 billion diverse math problems), a large number of diverse prompts are needed.

At present, two paradigms are employed to diversify the data synthesis prompt.

Previous research tends to diversify the data synthesis prompt through the following two paradigms, but unfortunately, neither can practically achieve scalable synthetic data creation:
Instance-driven: This approach diversifies the data synthesis prompt by leveraging a seed corpus (i.e., creating new instances based on the instances in the seed corpus). However, under this paradigm, the diversity of the synthesized data mainly comes from the seed instances, making it difficult to truly extend beyond the seed corpus. Given the limited size of a seed corpus in most practical scenarios, it is challenging for this paradigm to scale up the creation of synthetic data.
Key-point-driven: This approach diversifies the data synthesis prompt with a curated comprehensive list of key points (or concepts), which may include topics, subjects, or any knowledge that synthetic data is intended to cover. However, this methodology also faces challenges in scaling synthetic data creation, as compiling a thorough list of key points across various levels of granularity is practically unfeasible-unless the scope is constrained to a narrow and specific domain (e.g., mathematics).

In this disclosure, various embodiments are described to effectively enable the large-scale creation of diverse synthetic data. Specifically, a persona-driven data synthesis methodology is proposed. This methodology is inspired by the observation that adding a persona to a data synthesis prompt can steer the LLM towards the corresponding perspective to create distinctive synthetic data. That is, when generating the synthetic data, the LLM takes the input persona into account. As almost any LLM use case can be associated with a specific persona, this methodology may be adopted broadly. A comprehensive, diverse persona collection, also known as a persona hub, is constructed, which enables us to create all-encompassing synthetic data at scale.

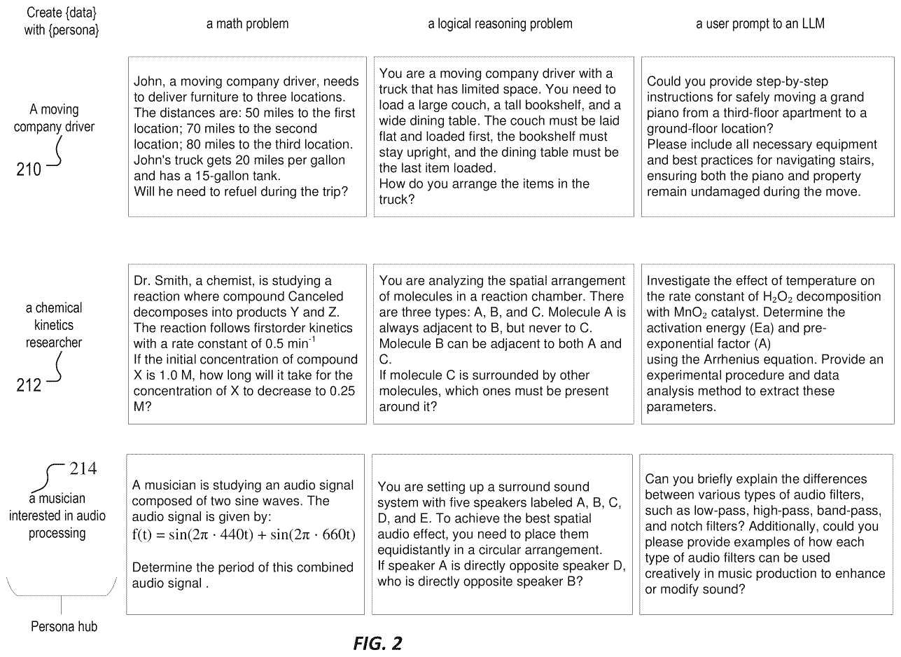

FIG. 2 shows an exemplary use case in which the persona hub is employed. The persona hub is a collection of large and diverse group of personas. For example, it may contain over 1 billion persona records. FIG. 2 shows 3 personas are selected from the persona hub: a moving company driver 210, a chemical kinetics research 212, and a musician interested in audio processing 214. As an example, a prompt to an LLM may be form by: create {data} with {persona}. The data portion may include any task, such as “a math problem”, “a logical reasoning problem”, or “a user prompt to an LLM”. Therefore, as shown in FIG. 2, a prompt may include: “create a math problem with a moving company driver” (i.e., the LLM taking the role of a moving company driver), “create a logical reasoning problem with a chemical kinetics researcher”, or “create a user prompt to an LLM with a musician interested in audio processing”. The nine text boxes in FIG. 2 show sample output synthetic data from the LLM. Therefore, by selecting a persona from the persona hub, and creating a prompt with the persona in consideration, the prompt may guide an LLM to synthesize data with corresponding persona. The vast amount of personas (e.g., 1 billion personas) in Persona Hub, which provide ample diversity, can facilitate synthetic data creation for various data synthesis scenarios at a billion scale.

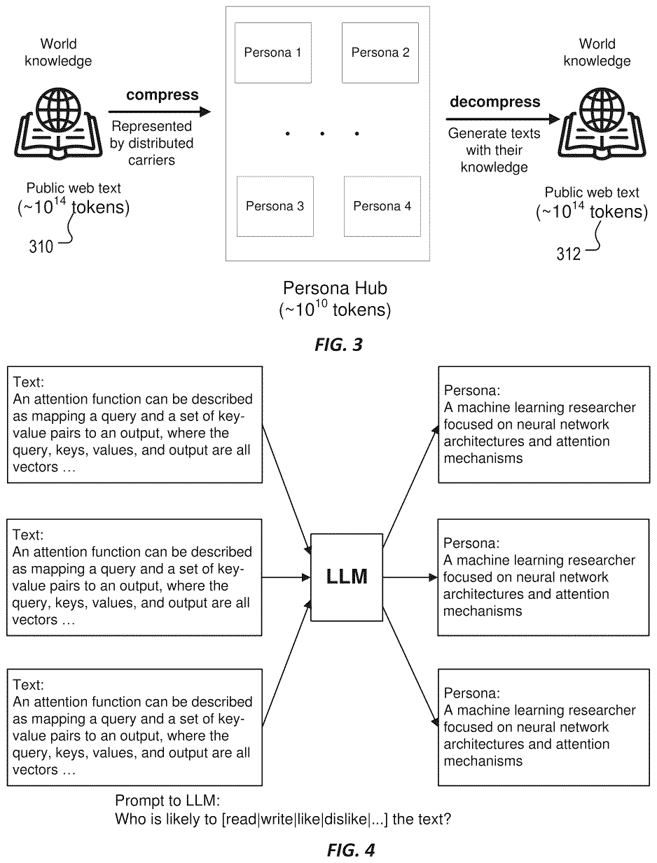

FIG. 3 shows an exemplary persona hub which contains, for example, over 1 billion diverse personas (˜13% of the world's total population). The raw data for constructing the persona hub may be extracted (e.g., via scraping) from all types of world knowledge sources, such a websites, books, journal, newspapers, magazines, videos, audios, etc. The raw data may include a list of data elements, and each data element may include at least one of: a text portion; an image portion; an audio portion, or a video portion.

Referring to FIG. 3, the personas (e.g., 1 billion personas in the persona hub) can be regarded as distributed carriers of world knowledge, and each individual persona can be associated with its unique knowledge, experience, interest, personality and profession. Therefore, the personas in the persona hub can tap into almost every perspective encapsulated within the LLM to create diverse synthetic data at scale, without being limited by the size of a seed corpus. Moreover, in contrast to key points driven approach that typically works with specific data synthesis prompts, personas according to this disclosure can be combined with almost any data synthesis prompt, benefiting from an LLM's strong roleplay ability, making them generally applicable to a wide range of data synthesis scenarios.

In FIG. 3, from a compression perspective, Persona Hub (˜10¹⁰ tokens) can be seen as the compressed form of world knowledge (e.g., public web text 310 for training LLMs, ˜10¹⁴ tokens) into distributed carriers. On the other hand, the public web text 312 can be seen as the decompressed content created by these personas with their knowledge and experiences.

### Persona Hub Construction

In this disclosure, a persona hub is constructed using two solutions, namely, text-to-persona, and persona-to-persona.

FIG. 4 shows an example for text-to-persona solution. The texts to the left of the LLM are example input to the LLM. These texts may include the data elements collected/scraped from information domain such as websites, as described earlier. A prompt to the LLM may be formed with these texts.

In some example implementations, the prompt may be in the form of: “Who is likely to [read|write|like|dislike| . . . ] the text”. For example, the prompt may be: who is likely to read “An attention function can be described as mapping a query and a set of key-value pairs to an output, where the query, keys, values, and output are all vectors . . . ”. With this prompt, the output from the LLM, which is a persona, may be: “A machine learning researcher focused on neural network architectures and attention mechanisms”. As can be seen, the persona generated by the LLM includes not only a profession of the persona (machine learning researcher), but also a detailed description in the professional field (“focused on neural network architectures and attention mechanisms”).

In some example implementations, the prompt may take other forms, such as “Who is likely to be associated with the text” or “Who is likely to be associated directly or indirectly with the text”. For example, the prompt may be: Who is likely to be associated with the text: “An attention function can be described as mapping a query and a set of key-value pairs to an output, where the query, keys, values, and output are all vectors . . . ”. The persona generated by the LLM may include “a hardware engineer who specialized in designing Graphics Processing Unit (GPU)”.

In some example implementations, the prompt may take other forms, such as “Who is likely to play a role associated with the text”.

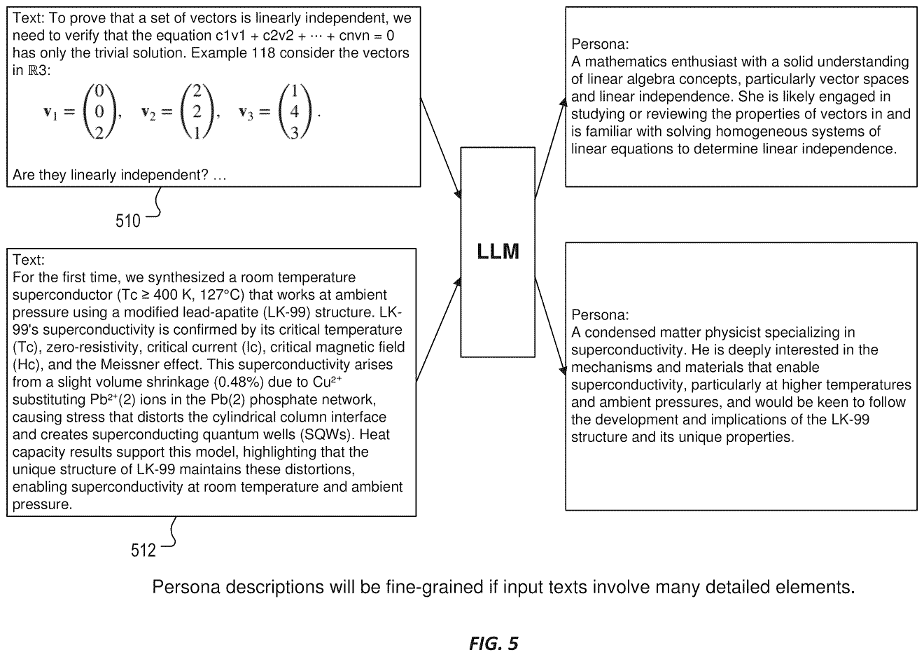

In some example implementations, a level of details comprised in the input text is positively correlated with a level of detail of the generated persona. Persona descriptions will be fine-grained if input texts involve many detailed elements. Turning to FIG. 5, the texts 510 and 512 used to form the LLM prompt include extensive details in the area of math and physics, respectively. For example, text 510 directs specifically to linear algebra (source of text may be from a mathematical textbook). The prompt to the LLM may be: who is likely to read the text? or who is likely to be interested to the text? The corresponding LLM generated synthetic data may be very specific, fine-grained, and may contain extensive details with respect to the persona. As shown in FIG. 5, an exemplary resulting synthetic data may be: “A mathematics enthusiast with a solid understanding of linear algebra concepts, particularly vector spaces and linear independence. She is likely engaged in studying or reviewing the properties of vectors in and is familiar with solving homogeneous systems of linear equations to determine linear independence.”.

In some example implementations, a desired persona detail may be specified in the prompt (e.g., in the level from 1 to 10, with 10 having the most detail). As an example, the prompt may be: using detail level 10, who is likely to read the text? The persona generated by the LLM will then have the corresponding details matching the specified level.

As the source of text data (e.g., from websites) is virtually unlimited and all-encompassing, a wide range of personas may be generated via the text-to-persona option, and these personas may encompass a wide range of aspects across different granularities.

Text-to-Persona is a highly scalable method that can synthesize personas covering almost every aspect. However, it may still miss some personas that have low visibility on the extracted/scraped data (e.g., from websites) and thus are less likely to obtain via text-to-persona, such as a member behind of scenes. For example, if the text is related to a movie, then a resulting persona from the LLM may include actor/actress of the movie, director of the movie. However, some crew members, such as sound technician, costume assistant, and catering service staffs, have low visibility. Such low visibility personas are hard to harvest via the text-to-persona option.

In this disclosure, a persona-to-persona solution is proposed. In this solution, an LLM may use an existing persona (e.g., created under the text-to-persona option) may be used as a seed persona, to generate one or more derived (supplemental) personas. The prompt may include an interpersonal relationship required with the seed persona.

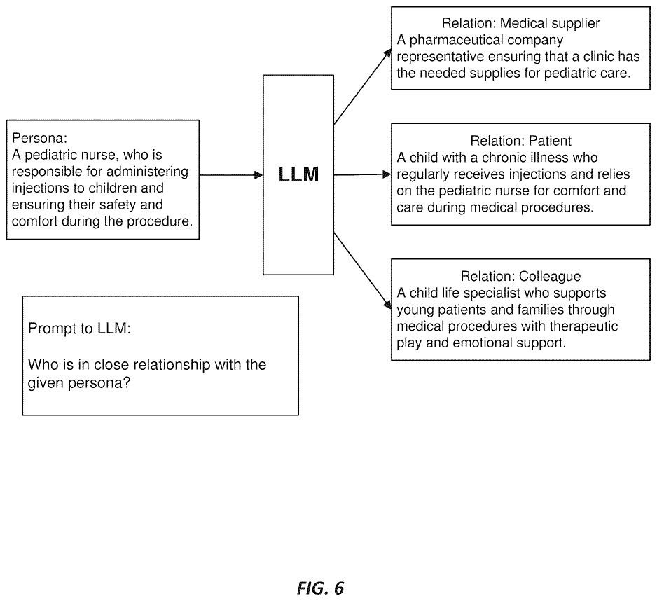

FIG. 6 shows an example for text-to-persona solution. The personal may be: “A pediatric nurse, who is responsible for administering injections to children and ensuring their safety and comfort during the procedure. The prompt to the LLM may be: “Who is in close relationship with the given persona?” FIG. 6 shows 3 resulting personals via different relationships, including a medical supplier relationship, a patient relationship, and a colleague relationship.

Similarly, if the seed persona is a movie's actor, then a costume assistant persona, and a sound technician persona may be the resulting persona.

In some example implementations, multiple iterations of persona relationship expansion may be performed for each persona obtained through Text-to-Persona, thereby the persona hub may be enriched even further. In some example implementations, six iterations may be performed. That is, persona A->persona B->persona C->persona D->persona E->persona F->persona G.

In some example implementations, after collecting/generating the personas (e.g., via text-to-persona, persona-to-persona), due to the size of collected personas (e.g., 1 billion), some of the personas may be very similar or even identical. Therefore, deduplication may be performed, to remove duplicated persona.

In some example implementations, a MinHash-based deduplication may be employed, which is based on the n-gram features of persona descriptions. In some example implementations, a 1-gram and a signature size of 128 are used for MinHash deduplication.

In some example implementations, after deduplication based on surface forms (e.g., MinHash with n-gram features), an Embedding-based deduplication may be employed. For example, personas with a cosine semantic similarity greater than a predefined/pre-configured threshold (e.g., 0.9, or other values) may be filtered out. The threshold value may be determined based a requirement for diversity. The higher the requirement for diversity, the lower the threshold could be set to. The personas after the deduplication will then be added to the persona hub.

The list below shows some example personas created based on above solutions.
A Political Analyst specialized in El Salvador's political landscape.
A legal advisor who understands the legal implications of incomplete or inaccurate project documentation.
A maternal health advocate focused on raising awareness about postpartum complications.
A school basketball team captain who believes sports and their funding should be prioritized over student council campaigns.
A determined basketball player who aspires to be the star athlete of the school.
A virtual reality content creator sharing their experiences and creations on a popular online platform.
An engineer with a shared sense of humor, who has known the comedian since grade school.
An IT project manager who adopted extreme programming (XP) methodologies on his own team.
A newly hired general counsel at TurpCo Industries.
A divorced father of three seeking legal representation for child custody matters.
A geography teacher who was born and raised in Antigua and Barbuda.
A talented athlete looking to improve their skills and gain exposure in international competitions.
A partner at the law firm, recognized for their extensive knowledge of healthcare laws.
A competitive badminton coach known for their aggressive training methods and emphasis on winning.
A young social worker who greatly admires Sadye L. Logan.
A software engineer specializing in document management systems, working closely with the graph.

### Synthetics Text/Date Creation

With the persona hub being constructed, synthetic data may be created based on it. One or more personas may be selected or sampled from the Persona Hub. Each of the selected persona will be used to form a data synthesis prompt, for example, by integrating the persona into an appropriate position in the data synthesis prompt. As the prompt has an embedded persona in it, it will drive the LLM to adopt the persona's perspective when creating synthetic data.

The personas created according to embodiments in this disclosure are compatible with various forms of prompts to create synthetic data.

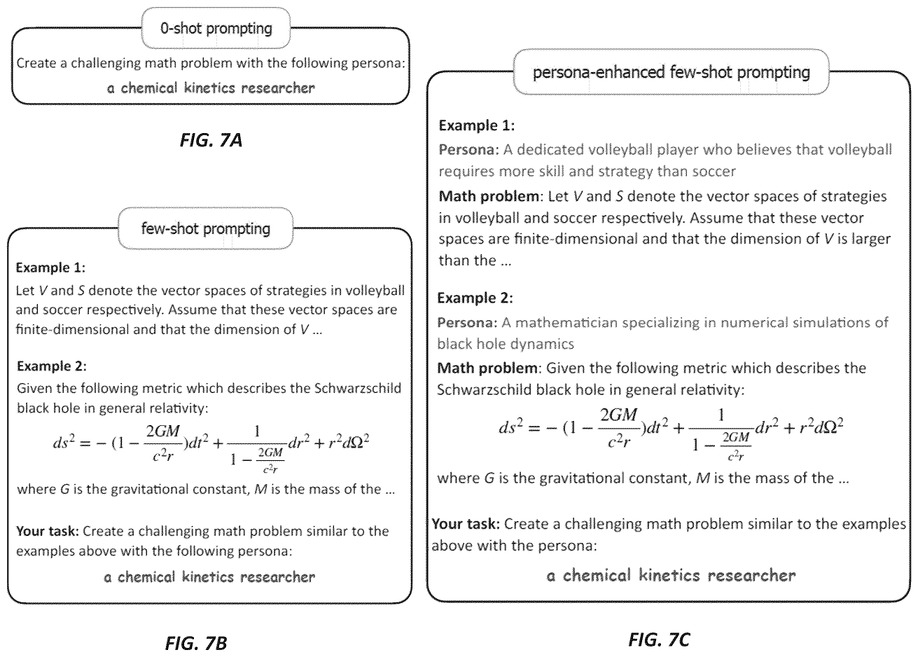

In some example implementations, a zero-shot-prompting may be used. Zero-shot prompting does not leverage any existing examples (i.e., demonstrations), thereby fully exploiting the model's creativity without being constrained by specific examples. FIG. 7A shows an exemplary 0-shot prompting, using a chemical kinetics researcher as the persona with no example provided.

In some example implementations, a few-shot prompting can better ensure that the synthesized data meets the requirements by providing some demonstrations. FIG. 7B shows an exemplary few-shot prompting, using a chemical kinetics researcher as the persona with two examples provided.

In some example implementations, a persona-enhanced few-shot prompting is more effective in enhancing the LLM's persona-driven data synthesis capabilities. FIG. 7C shows an exemplary persona-enhanced few-shot prompting, in which two examples provided, with each example being associated with a respective persona. The prompting task requires the LLM to use a chemical kinetics researcher as the persona when generate synthetic text.

Using the prompting techniques described above, and with the persons selected from the persona hub, an LLM may be prompted to generate versatile, diverse synthetic data. The persona-driven approach is general and versatile, making it easily adaptable to different data synthesis scenarios by adjusting the data synthesis prompt. Embodiments according to this disclosure may apply to a broad range of data synthesis scenarios, including the largescale creation of math and logical reasoning problems, instructions (i.e., user prompts), knowledge rich texts, game NPCs, and tool (function) development.

In some embodiment, the techniques discussed above may apply to math problem synthesis. When prompting an LLM to create a math problem, adding a persona leads the LLM to create math problems related to that persona. That is, when prompted with a particular persona, the LLM will create a problem in the context of that particular persona.

In general, a prompt to an LLM may include two parts: a persona part, and a task part. In other words, a prompt is a command, or an instruction to let LLM execute the task using the specified persona.

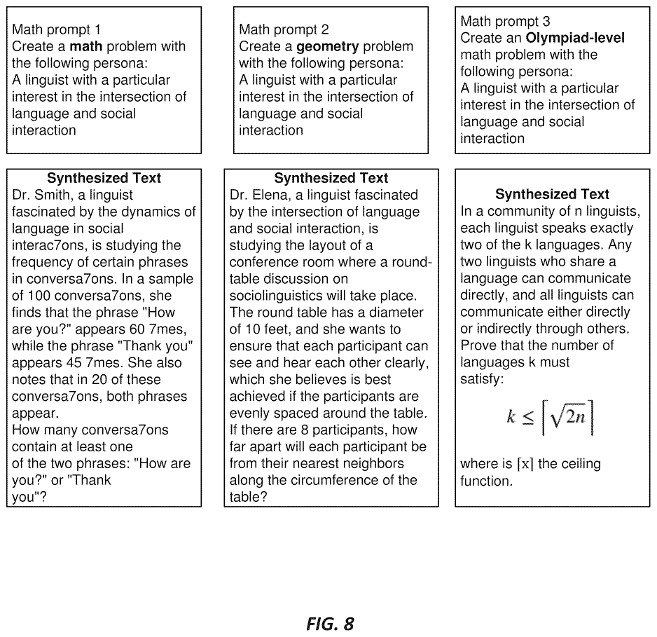

FIG. 8 shows various math problem creation prompts using a linguist persona.

In FIG. 8, math prompt 1 is in a general format, using a linguist with a particular interest in the intersection of language and social interaction.

A prompt may further include other criteria, such as a focus of the task, a difficulty level of the task, etc.

For example, in FIG. 8, math prompt 2 specifies a focus (e.g., geometry) on the math problem. Under this prompt, the synthesized text is steered to the geometry direction.

In FIG. 8, math prompt 3 specifies a difficulty level (e.g., Olympiad-level). Under this prompt, the math problem specified by synthesized text is remarkable more difficult compared with the previous two math problems.

Note that multiple criteria may be incorporated into a task to make a prompt more focused. For example, the math prompt may be: “Create an Olympiad-level math problem in geometry with the following persona”. In this prompt, two criteria are used: 1. Olympiad-level; and 2. geometry.

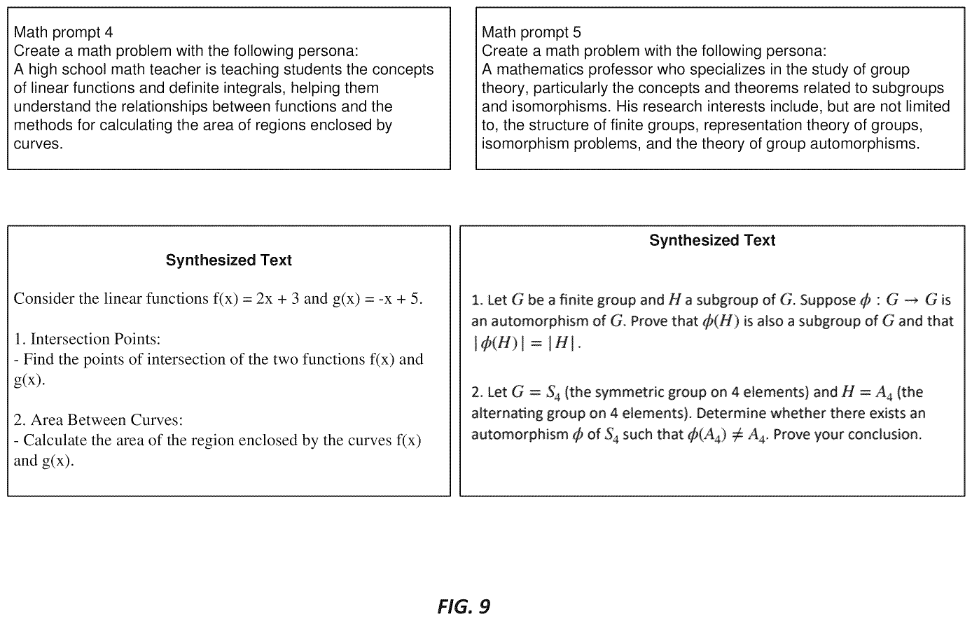

Similarly, by tuning the persona part of the prompt, an LLM may generate different synthetic text. FIG. 9 shows two math problem prompts created with personas of professionals related to the field of mathematics.

In FIG. 9, math problem prompt 4 using such persona: “high school math teacher is teaching students the concepts of linear functions and definite integrals, helping them understand the relationships between functions and the methods for calculating the area of regions enclosed by curves”. Math problem prompt 5 using such persona: “A mathematics professor who specializes in the study of group theory, particularly the concepts and theorems related to subgroups and isomorphisms. His research interests include, but are not limited to, the structure of finite groups, representation theory of groups, isomorphism problems, and the theory of group automorphisms”. As shown in FIG. 9, the synthesized texts tend to be more challenging than those created with general personas because they usually require a deeper and more fine-grained understanding of advanced mathematical knowledge and skills. By giving a fine-grained persona in the prompt, the LLM is steered toward the specific direction described by the details of the persona.

As illustrated in FIG. 8, a prompt to the LLM may use a general persona, who does not necessarily have a profession in the area specified by the task. For example, a linguist persona may be used to create a math problem (which may be related to language), a soccer player persona may also be used to create a math problem (which may be related to playing soccer, such as what is a best angle to curve the soccer ball).

As illustrated in FIG. 9, a prompt to the LLM may use a more specific persona, who is in the same field as the task. For example, a math problem may be created for a math teacher persona, or a math professor persona. Both of them are in (or related) to the mathematics field. Personas of math professionals often mention more advanced and granular mathematics knowledge and skills compared with general persona, which in turn allows the created math problems to cover more specific mathematical concepts in great depth, making them more challenging.

Due to the vast size (e.g., one billion) of the persona hub, the diversity of the persona is significantly expanded, and therefore, resulting in highly diverse synthetic data generated via the persona specific prompts.

In the field of LLM training, one known issue is that if the input training data lacks diversity, it may lead to collapse of the LLM. In some example implementations, after the diverse synthetic data has been generated via embodiments in this disclosure, it can be used as high quality input data to train and/or fine tune another LLM, avoiding the model collapse issue.

In some example implementations, the diverse synthetic data may be used by organizations, which need to train their own customized LLM mode to meet their special requirement. The high quality, diverse synthetic data generate according to embodiment of this disclosure may be used as training data to reduce costs while still achieving a high-quality LLM model.

As the LLM is getting more and more complicated, undergoing many iterations, it is getting harder and harder to have clear view on LLM's knowledge, or LLM's world view. In some example implementations, diversified synthetic data generated according to embodiments of this disclosure may be used as input to an LLM, to get a dump of LLM's internal core (or LLM's world view). This may benefit debugging work, and the dumped information may be used to direct further LLM tuning.

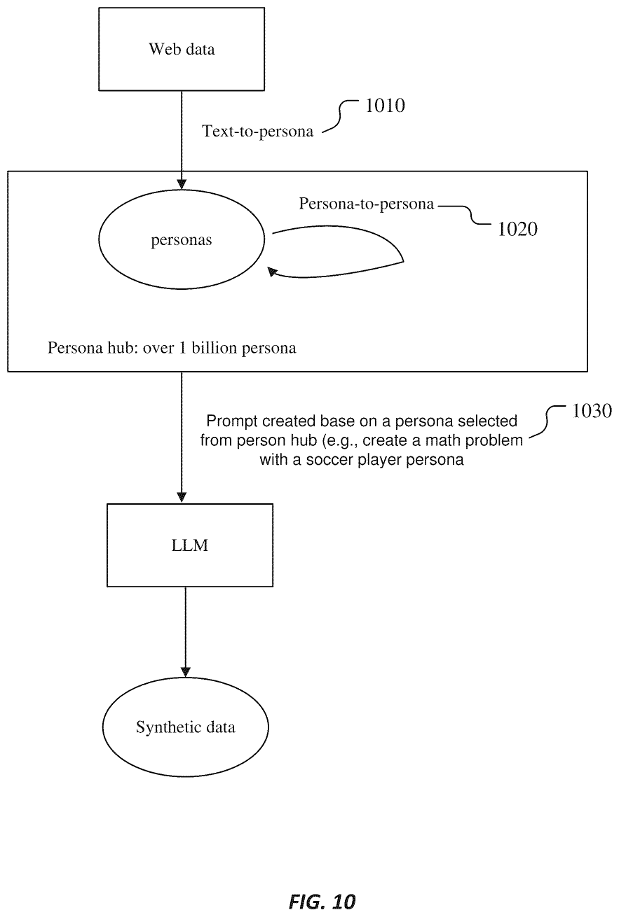

FIG. 10 illustrates a high level flow chart according to embodiments of this disclosure.

In step 1010, raw data representing world knowledge may be extracted or scraped from an information domain comprising websites, the raw data includes a set of data elements, and each data element in the set of data elements includes at least one of: a text portion; an image portion; an audio portion; or a video portion. Note that portions other than text portion may be converted to text format in post-processing.

Then, the text-to-persona technique may be employed. That is, one or more (or all) the data elements may be used to form a prompt to an LLM, and the LLM will output a corresponding persona. The prompt may be in the form of:
who is likely to read, write, like, or dislike the data element;
who is likely to be associated directly or indirectly with data element; or
who is likely to play a role in the data element.

In step 1020, the personas generated may be used as seed persona, to generate more personas via the persona-to-persona option. Specifically, the inference may be based one following relationship:
a working relationship;
a transactional relationship;
an administration relationship;
an authority-based relationship;
a collaborative relationship; or
an interdisciplinary relationship;
a social relationship; or
an ethical or religion relationship.

After step 1020, a persona hub may be constructed in a very large scale. For example, the persona hub may include over 1 billion persons.

In step 1030, prompts to be used for synthesizing text data may be formulated using one or more persons selected from the persona hub. For example, the prompt may be: “create a math problem with a soccer player persona”, or “create a Olympiad-level math problem with a soccer player persona”.

In some example implementations, the prompt to the LLM may include a task portion, such as:
creating a question or a problem;
creating an instruction or a prompt for LLM;
creating a tool or a function of the tool; or
creating a Non-Player Character (NPC) for a game.

Using these prompts formulated with persona and tasks, the LLM is steered by, for example, assuming the specified personal to execute the task. Therefore, the output synthetic text focuses on the context of the persona and the task.

Note that LLMs are used in various stages. For example, a first LLM may be used in the text-to-persona task, a second LLM may be used in the persona-to-persona task, and a third LLM may be used to generate synthetic text with persona specific prompts. These LLMs may be the same, or different, based on implementation requirement.

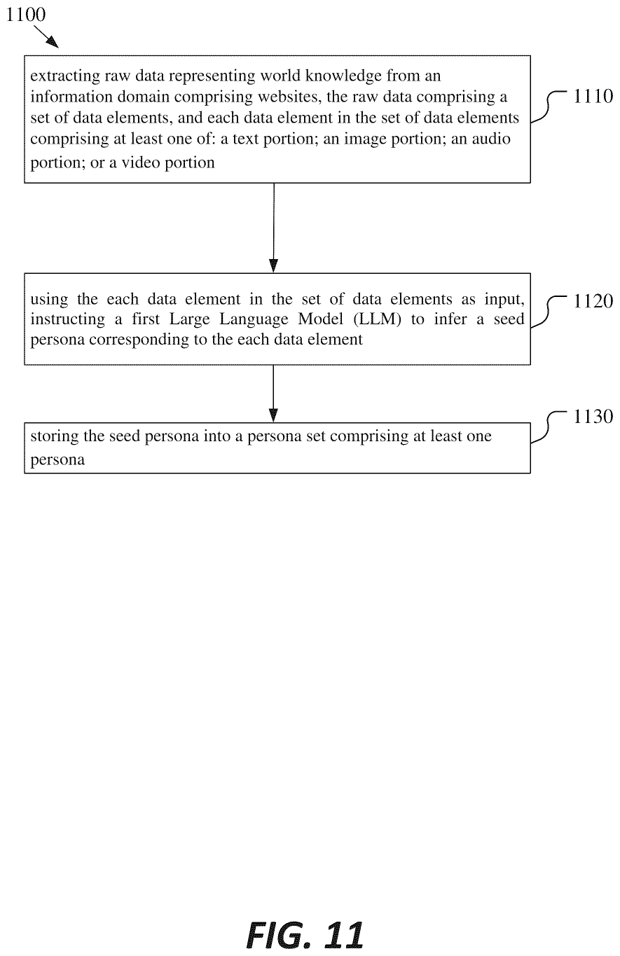

FIG. 11 shows an exemplary method 1100 for data processing and Large Language Model (LLM) training. The method 1100 may include a portion or all of the following step: step 1110, extracting raw data representing world knowledge from an information domain comprising websites, the raw data comprising a set of data elements, and each data element in the set of data elements comprising at least one of: a text portion; an image portion; an audio portion; or a video portion; step 1120, using the each data element in the set of data elements as input, instructing a first LLM to infer a seed persona corresponding to the each data element; and step 1130, storing the seed persona into a persona set comprising at least one persona.

In any portion or combination of the implementations above, each personal in the persona set comprises at least one of: a demographic Information; an experience or expertise; an interest or hobby; or a personality characteristic.

In any portion or combination of the implementations above, a level of detail comprised in the each data element in the set of data elements is positively correlated with a level of detail of the seed persona.

In any portion or combination of the implementations above, instructing the first LLM to infer the seed persona includes instructing the LLM in one of following manners: who is likely to read, write, like, or dislike the each data element in the set of data elements; who is likely to be associated directly or indirectly with the each data element in the set of data elements; or who is likely to play a role in the each data element in the set of data elements.

In any portion or combination of the implementations above, the method may further include: instructing the first LLM to generate a supplemental persona that is associated with the seed persona; and storing the supplemental persona into the persona set.

In any portion or combination of the implementations above, the method may further include: performing de-duplication on personas in the persona set, based on a similarity threshold using at least one of following methods: a MinHash-based Deduplication method; or an Embedding-based Deduplication method, wherein the similarity threshold is determine based on a requirement on persona diversity.

In any portion or combination of the implementations above, instructing the first LLM to generate the supplemental persona may include instructing the first LLM to generate the supplemental persona based on a relationship between the supplemental persona and the seed persona, wherein the supplemental persona and the seed persona having at least one of following relationships: a working relationship; a transactional relationship; an administration relationship; an authority-based relationship; a collaborative relationship; an interdisciplinary relationship; a social relationship; or an ethical or religion relationship.

In any portion or combination of the implementations above, the method may further include: using a command prompt indicating a task to instruct a second LLM to output synthesized data, the command prompt comprising at least one of: a task; or a persona selected from the persona set.

In any portion or combination of the implementations above, the command prompt instructs the second LLM to generate the synthesized data by executing the task by assuming a role of the persona.

In any portion or combination of the implementations above, the task comprises at least one of: creating a question or a problem; creating an instruction or a prompt for LLM; creating a tool or a function of the tool; or creating a Non-Player Character (NPC) for a game.

In any portion or combination of the implementations above, the persona is in a same field or a same area as the task; or the persona is in a different field or a different area compared with the task.

In any portion or combination of the implementations above, the task is specified with at least one of: a focus of the task; or a difficulty level of the task.

In any portion or combination of the implementations above, the method may further include: using the output synthesized data as training data, to train or tune a third LLM.

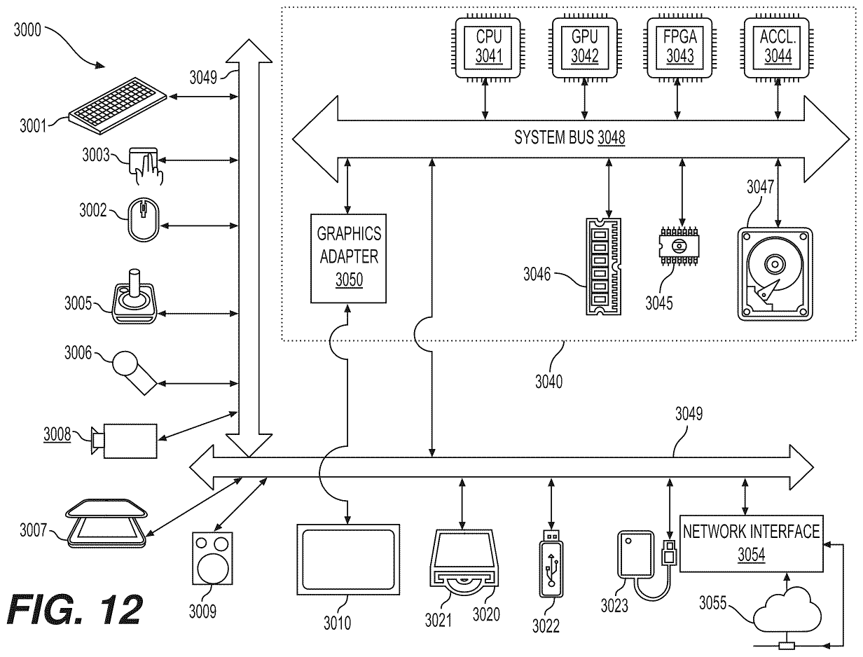

The techniques described above, can be implemented as computer software using computer-readable instructions and physically stored in one or more computer-readable media. For example, FIG. 12 shows a computer system (3000) suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 30 for computer system (3000) are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system (3000).

Computer system (3000) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (3001), mouse (3002), trackpad (3003), touch screen (3010), data-glove (not shown), joystick (3005), microphone (3006), scanner (3007), camera (3008).

Computer system (3000) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (3010), data-glove (not shown), or joystick (3005), but there can also be tactile feedback devices that do not serve as input devices), audio output devices (such as: speakers (3009), headphones (not depicted)), visual output devices (such as screens (3010) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (3000) can also include human accessible storage devices and their associated media such as optical media including CD/DVD ROM/RW (3020) with CD/DVD or the like media (3021), thumb-drive (3022), removable hard drive or solid state drive (3023), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (3000) can also include an interface (3054) to one or more communication networks (3055). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CAN bus, and so forth. Certain networks commonly require external network interface adapters that attached to certain general-purpose data ports or peripheral buses (3049) (such as, for example USB ports of the computer system (3000)); others are commonly integrated into the core of the computer system (3000) by attachment to a system bus as described below (for example Ethernet interface into a PC computer system or cellular network interface into a smartphone computer system). Using any of these networks, computer system (3000) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (3040) of the computer system (3000).

The core (3040) can include one or more Central Processing Units (CPU) (3041), Graphics Processing Units (GPU) (3042), specialized programmable processing units in the form of Field Programmable Gate Areas (FPGA) (3043), hardware accelerators for certain tasks (3044), graphics adapters (3050), and so forth. These devices, along with Read-only memory (ROM) (3045), Random-access memory (3046), internal mass storage such as internal non-user accessible hard drives, SSDs, and the like (3047), may be connected through a system bus (3048). In some computer systems, the system bus (3048) can be accessible in the form of one or more physical plugs to enable extensions by additional CPUs, GPU, and the like. The peripheral devices can be attached either directly to the core's system bus (3048), or through a peripheral bus (3049). In an example, the screen (3010) can be connected to the graphics adapter (3050). Architectures for a peripheral bus include PCI, USB, and the like.

CPUs (3041), GPUs (3042), FPGAs (3043), and accelerators (3044) can execute certain instructions that, in combination, can make up the aforementioned computer code. That computer code can be stored in ROM (3045) or RAM (3046). Transitional data can also be stored in RAM (3046), whereas permanent data can be stored for example, in the internal mass storage (3047). Fast storage and retrieve to any of the memory devices can be enabled through the use of cache memory, that can be closely associated with one or more CPU (3041), GPU (3042), mass storage (3047), ROM (3045), RAM (3046), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As a non-limiting example, the computer system having architecture (3000), and specifically the core (3040) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (3040) that are of non-transitory nature, such as core-internal mass storage (3047) or ROM (3045). The software implementing various embodiments of the present disclosure can be stored in such devices and executed by core (3040). A computer-readable medium can include one or more memory devices or chips, according to particular needs. The software can cause the core (3040) and specifically the processors therein (including CPU, GPU, FPGA, and the like) to execute particular processes or particular parts of particular processes described herein, including defining data structures stored in RAM (3046) and modifying such data structures according to the processes defined by the software. In addition or as an alternative, the computer system can provide functionality as a result of logic hardwired or otherwise embodied in a circuit (for example: accelerator (3044)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

A person of ordinary skill in the art may understand that all or some of the steps of the methods in the foregoing embodiments may be implemented by a program instructing relevant hardware. The program may be stored in a non-transitory computer-readable storage medium. The non-transitory computer-readable storage medium may be the computer-readable storage medium included in the memory in the foregoing embodiments, or may be a computer-readable storage medium that exists independently and that is not assembled in a terminal. The non-transitory computer-readable storage medium stores at least one instruction, at least one program, a code set, or an instruction set, and the at least one instruction, the at least one program, the code set, or the instruction set is loaded and executed by the processor to implement the embodiment according to this disclosure.

Optionally, the non-transitory computer-readable storage medium may include: a ROM, a RAM, a solid state drive (SSD), an optical disc, or the like. The RAM may include a resistance random access memory (ReRAM) and a dynamic random access memory (DRAM). The sequence numbers of the foregoing embodiments of this disclosure are merely for description purpose, and are not intended to indicate priorities of the embodiments.

According to an aspect of this application, a computer program product or a computer program is provided, including computer instructions, the computer instructions being stored in a non-transitory computer-readable storage medium. A processor of a computer device reads a computer instruction from a non-transitory computer-readable storage medium, and executes the computer instruction, so that the computer device performs the protein structure information prediction method provided in various optional implementations of the foregoing aspects.

A person of ordinary skill in the art may understand that all or some of the steps of the foregoing embodiments may be implemented by using hardware, or may be implemented by a program instructing relevant hardware. The program may be stored in a non-transitory computer-readable storage medium. The non-transitory storage medium may be a ROM, a magnetic disk, an optical disc, or the like.

The foregoing descriptions are merely exemplary embodiments of this disclosure, but are not intended to limit this application. Any modification, equivalent replacement, improvement, and the like made within the spirit and principle of this application shall fall within the protection scope of this application.

1. A method for data processing and Large Language Model (LLM) training, the method comprising:
extracting raw data representing world knowledge from an information domain comprising websites, the raw data comprising a set of data elements, and each data element in the set of data elements comprising at least one of: a text portion; an image portion; an audio portion; or a video portion;
using the each data element in the set of data elements as input, instructing a first LLM to infer a persona corresponding to the each data element;
using the persona as a seed persona and storing the seed persona into a persona set;
generating, based on the seed persona in the persona set, more personas and storing more personas into the persona set, the more personas representing separate entities from the seed persona; and
generating synthesized data based on at least one persona from the persona set.

2. The method of claim 1, wherein each persona in the persona set comprises at least one of:
a demographic information;
an experience or expertise;
an interest or hobby; or
a personality characteristic.

3. The method of claim 1, wherein a level of detail comprised in the each data element in the set of data elements is positively correlated with a level of detail of the seed persona.

4. The method of claim 1, wherein instructing the first LLM to infer the persona comprises instructing the LLM in one of following manners:
who is likely to read, write, like, or dislike the each data element in the set of data elements;
who is likely to be associated directly or indirectly with the each data element in the set of data elements; or
who is likely to play a role in the each data element in the set of data elements.

5. The method of claim 1, further comprising:
instructing the first LLM to generate a supplemental persona that is associated with the seed persona; and
storing the supplemental persona into the persona set.

6. The method of claim 5, further comprising:
performing de-duplication on personas in the persona set, based on a similarity threshold using at least one of following methods: a MinHash-based Deduplication method; or an Embedding-based Deduplication method, wherein the similarity threshold is determined based on a requirement on persona diversity.

7. The method of claim 5, wherein instructing the first LLM to generate the supplemental persona comprises instructing the first LLM to generate the supplemental persona based on a relationship between the supplemental persona and the seed persona, wherein the supplemental persona and the seed persona having at least one of following relationships:
a working relationship;
a transactional relationship;
an administration relationship;
an authority-based relationship;
a collaborative relationship;
an interdisciplinary relationship;
a social relationship; or
an ethical or religion relationship.

8. The method of claim 1, further comprising:
using a command prompt indicating a task to instruct a second LLM to output synthesized data, the command prompt comprising at least one of: a task; or a persona selected from the persona set.

9. The method of claim 8, wherein the command prompt instructs the second LLM to generate the synthesized data by executing the task by assuming a role of the persona.

10. The method of claim 8, wherein the task comprises at least one of:
creating a question or a problem;
creating an instruction or a prompt for LLM;
creating a tool or a function of the tool; or
creating a Non-Player Character (NPC) for a game.

11. The method of claim 8, wherein:
the persona is in a same field or a same area as the task; or
the persona is in a different field or a different area compared with the task.

12. The method of claim 8, wherein the task is specified with at least one of:
a focus of the task; or
a difficulty level of the task.

13. The method of claim 8, wherein the command prompt is generated via at least one of:
a o-shot prompting;
a few-shot prompting; or
a persona-enhanced few-shot prompting.

14. The method of claim 8, further comprising:
using the output synthesized data as training data, to train or tune a third LLM.

15. A device comprising a memory for storing computer instructions and a processor in communication with the memory, wherein, when the processor executes the computer instructions, the processor is configured to cause the device to:
extract raw data representing world knowledge from an information domain comprising websites, the raw data comprising a set of data elements, and each data element in the set of data elements comprising at least one of: a text portion; an image portion; an audio portion; or a video portion;
use the each data element in the set of data elements as input, instructing a first LLM to infer a persona corresponding to the each data element;
use the persona as a seed persona and store the seed persona into a persona set;
generate, based on the seed persona in the persona set, more personas and store more personas into the persona set, the more personas representing separate entities from the seed persona; and
generate synthesized data based on at least one persona from the persona set.

16. The device of claim 15, wherein each persona in the persona set comprises at least one of:
a demographic information;
an experience or expertise;
an interest or hobby; or
a personality characteristic.

17. The device of claim 15, wherein, when the processor is configured to cause the device to instruct the first LLM to infer the persona, the processor is configured to cause the device to instruct the first LLM in one of following manners:
who is likely to read, write, like, or dislike the each data element in the set of data elements;
who is likely to be associated directly or indirectly with the each data element in the set of data elements; or
who is likely to play a role in the each data element in the set of data elements.

18. The device of claim 15, wherein, when the processor executes the computer instructions, the processor is configured to further cause the device to:
instruct the first LLM to generate a supplemental persona that is associated with the seed persona; and
store the supplemental persona into the persona set.

19. The device of claim 15, wherein, when the processor executes the computer instructions, the processor is configured to further cause the device to:
use a command prompt indicating a task to instruct a second LLM to output synthesized data, the command prompt comprising at least one of: a task; or a persona selected from the persona set.

20. A non-transitory storage medium for storing computer readable instructions, the computer readable instructions, when executed by a processor, causing the processor to:
extract raw data representing world knowledge from an information domain comprising websites, the raw data comprising a set of data elements, and each data element in the set of data elements comprising at least one of: a text portion; an image portion; an audio portion; or a video portion;
use the each data element in the set of data elements as input, instructing a first LLM to infer a persona corresponding to the each data element;
use the persona as a seed persona and store the seed persona into a persona set;
generate, based on the seed persona in the persona set, more personas and store more personas into the persona set, the more personas representing separate entities from the seed persona; and
generate synthesized data based on at least one persona from the persona set.
